(19) United States
(12) Patent Application Publication
(10) Pub. No.: US 2013/0127908 A1
(43) Pub. Date: May 23, 2013

(54) METHOD AND APPARATUS FOR DYNAMIC PLACEMENT OF A GRAPHICS DISPLAY WINDOW WITHIN AN IMAGE

(71) Applicant: Aravind Soundararajan, Bangalore (IN)

(72) Inventor: Aravind Soundararajan, Bangalore (IN)

(73) Assignee: GENERAL INSTRUMENT CORPORATION, Horsham, PA (US)

(21) Appl. No.: 13/302,173

(22) Filed: Nov. 22, 2011

(51) Int. Cl. G09G 5/377

(52) U.S. Cl. 345/636; 345/634

(57) ABSTRACT

Disclosed is a method (800) for dynamically selecting a graphics display window within an image. A spatial gradient measurement is performed (805) on the image. Convoluted pixel values are calculated (810) for the image. A plurality of image characteristics for a plurality of window position options is determined (815) using the calculated convoluted pixel values. The plurality of window position options have a geometry that is able to accommodate a geometry of a graphics display. Graphics are placed (820) in one of the plurality of window position options based on the plurality of image characteristics.

### BACKGROUND

Presently, devices that render streaming video are able to render overlying graphics in pre-determined window slots. The graphics could be in the form of captions (EIA-608 and EIA-708 digital closed captioning) and other on-screen displays (OSD) that are tied to the frame Presentation Time. Because positions for these captions and OSDs are pre-determined, in many cases some interesting portion of the video window may, in operation, be covered by the graphics display. This frustrates the user in many cases, especially in the case of 708 data where bigger bitmaps can be rendered.

Because current graphics solutions employ pre-determined positioning, there is presently no way of minimizing situations where graphics display may cover important information in the underlying image(s). Therefore, there is an opportunity to develop a solution that places a graphics display window in a location that obstructs the underlying video less.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system 100 for streaming or broadcasting media content;

FIG. 2 illustrates an example of an original image 210 and an edge detected image 205;

FIG. 3, FIG. 4, and FIG. 5 illustrate exemplary methods of performing edge detection;

FIG. 6 illustrates an exemplary Sobel Mask 600;

FIG. 7 illustrates a Sobel Method analysis according to one embodiment;

FIG. 8 illustrates a method 800 for dynamically selecting a graphics display window for an image, according to one embodiment;

FIG. 9 illustrates one embodiment 900 of an image having four windows or quadrants;

FIG. 10 illustrates one embodiment 1000 of an image having four windows or quadrants;

FIG. 11 illustrates a method 1100 for dynamically selecting a graphics display window, according to one embodiment; and

FIG. 12 illustrates a block diagram of an example device 900 according to one embodiment.

### DETAILED DESCRIPTION

For the purposes of this disclosure, image or “image data” refers to a frame of streamed or broadcast media content, which can be live or pre-recorded. In addition, graphics or “graphics data” refers to closed-caption information. The closed captioning information or data may overlay a sequence of image data (e.g., as video or video data).

Disclosed is a method for dynamically placing a graphics display window within an image. The graphics display window determines the boundaries for placement of closed captioning graphics. If a closed caption mode allows a maximum of 4 rows and 32 columns of text (e.g., roll-up mode), then the graphics display window will accommodate this geometry, and the text will be placed within this window and overlap the image also being displayed.

The image may be one of a plurality of video frames presented in real-time. In one embodiment, a spatial gradient measurement is performed on the image. Convoluted pixel values are calculated for the image. A plurality of image characteristics for a plurality of window position options is determined using the calculated convoluted pixel values. The plurality of window position options has a geometry that is able to accommodate the graphics as displayed. The graphics display is placed in one of the plurality of window position options based on the plurality of image characteristics. In one embodiment, the graphics display may be presented using a variety of modes, including, but not limited to: pop-up, roll-on, and paint-on.

The image characteristic may be an amount of edges or edge pixels in the image. Using this method, closed captioning or graphics data having a particular graphics display window geometry can be overlaid in an area of the image having a shape that is at least as large as the graphics display window and having a least number of edges or edge pixels relative to other locations in the image having the graphics display window geometry.

Alternately, the image characteristic may be an amount of information in the image. Similarly, closed captioning data may be placed in an area of the image that accommodates the graphics data geometry and that has a least amount of information compared to other locations in the image having the closed captioning data geometry.

Note that the edge detection can occur over more than one image, e.g. for a sequence of video frames. A plurality of cumulative image characteristics for the plurality of window position options is determined for the sequence video frames. Thus, during a segment of video, graphics data can be placed in an area that accommodates the graphics data and has the least number of edges and/or the least amount of information over the time period of the video segment. The graphics display may be presented using different modes including, but not limited to: roll-on, paint-on, and pop-up.

Because the graphics data may “jump” around the video image when this method is used, dynamic placement of the graphics display window may be enabled and disabled by selections received via user input. Dynamic placement of the graphics display window may also (or alternately) be automatically disabled and enabled based on an amount of motion or an amount of information change in a given video frame sequence. When the dynamic placement is disabled, the graphics display window remains in the same area on the image, which may be the most-recently placed window or a default position (e.g., the top or bottom margin of the image).

Because the graphics display window may be placed anywhere on the image, there may be a large number of possible placement options having image characteristics to be compared. (The smaller the window, the more locations it can be placed within an image.) To reduce the number of comparisons, in another embodiment predetermined areas in the image are analyzed. These predetermined areas may be statically-located and non-overlapping or overlapping. Then, instead of comparing image characteristics of all the possibilities for graphics window placement, the image characteristics for only the predetermined areas are compared. Inside the single predetermined area with the least number of edges or lowest amount of information, the graphics display window is placed in a sub-area that has the least number of edges or lowest amount of information. Thus, this two-level analysis is quicker but limits the graphics display window to being inside one of the predetermined areas. The graphics display may be presented using different modes including, but not limited to: roll-on, paint-on, and pop-up.

Disclosed is an apparatus for dynamically selecting a graphics display window for an image. The apparatus has a memory. The apparatus also has a processor configured to: perform a two-dimensional spatial gradient measurement on the image; calculate convoluted pixel values for the image; determine a plurality of image characteristics for a plurality of window position options using the calculated convoluted pixel values, the plurality of window position options having a geometry that is able to accommodate a geometry of a graphics display; and place closed captioning or graphics data in one of the plurality of window position options based on the plurality of image characteristics.

Also disclosed is a non-transitory computer-readable storage medium with instructions that, when executed by a processor, perform the following method: performing a two-dimensional spatial gradient measurement on the image; calculating convoluted pixel values for the image; determining a plurality of image characteristics for a plurality of window position options using the calculated convoluted pixel values, the plurality of window position options having a geometry that is able to accommodate a geometry of a graphics display; and placing the closed captioning or graphics display in one of the plurality of window position options based on the plurality of image characteristics.

The present disclosure seeks to place a graphics display window in an area of an image frame having the least information. In one embodiment, this is done by using edge detection methods, where the window having the least number of detected edges is chosen. The present disclosure is not limited to graphics tied to frame presentation time stamps and can be extended to any type of graphics display screens. In addition, although the disclosure refers to closed captioning as the primary example of graphics, the methods presented herein may also be applied to dynamic or automatic placement of text for open captions, e.g. subtitles, or other types of graphics in media content, e.g. television network logos or sports team logos.

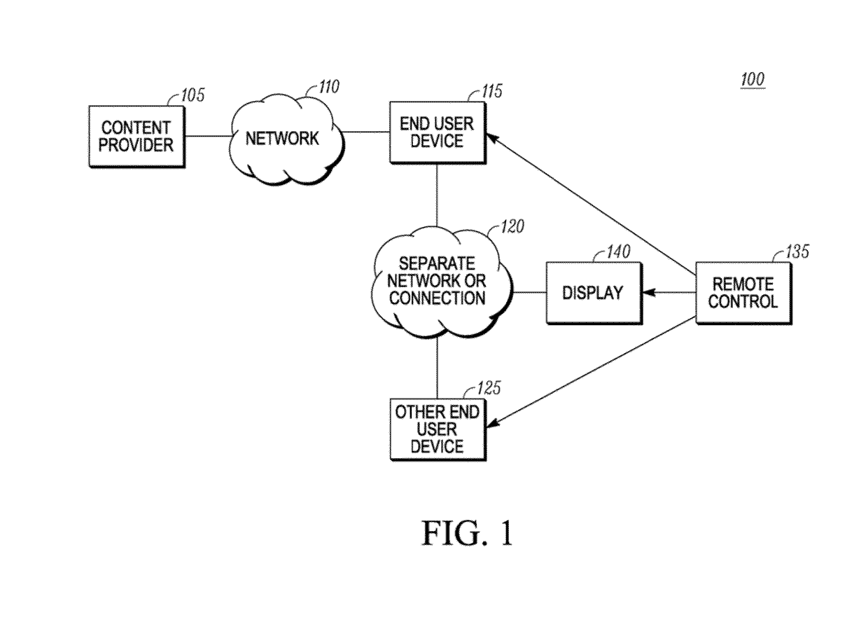

FIG. 1 illustrates an exemplary system 100 for streaming or broadcasting media content. Content provider 105 streams media content via network 110 to end-user device 115. Content provider 105 may be a headend, e.g., of a satellite television system or Multiple System Operator (MSO), or a server, e.g., a media server or Video on Demand (VOD) server. Network 110 may be an internet protocol (IP) based network. Network 110 may also be a broadcast network used to broadcast television content where content provider 105 is a cable or satellite television provider. In addition network 110 may be a wired, e.g., fiber optic, coaxial, or wireless access network, e.g., 3G, 4G, Worldwide Interoperability for Microwave Access (WiMAX), High Speed Packet Access (HSPA), HSPA+, Long Term Evolution (LTE).End user device 115 may be a set top box (STB), personal digital assistant (PDA), digital video recorder (DVR), computer, or mobile device, e.g., a laptop, netbook, tablet, portable media player, or wireless phone. In one embodiment, end user device 115 functions as both a STB and a DVR. In addition, end user device 115 may communicate with other end user devices 125 via a separate wired or wireless connection or network 120 via various protocols, e.g., Bluetooth, Wireless Local Area Network (WLAN) protocols. End user device 125 may comprise similar devices to end user device 115. In one embodiment, end user device 115 is a STB and other end user device 125 is a DVR.

Display 140 is coupled to end user devices 115, 125 via separate network or connection 120. Display 140 presents multimedia content comprised of one or more images having a dynamically selected graphics display window. The one or more images may be generated by end user devices 115, 125 or content provider 105. The one or more images may be video frames, e.g. a single image of a series of images that when displayed in sequence, create the illusion of motion.

Remote control 135 may be configured to control end user devices 115, 125 and display 140. Remote control 135 may be used to select various options presented to a user by end user devices 115, 125 on display 140.

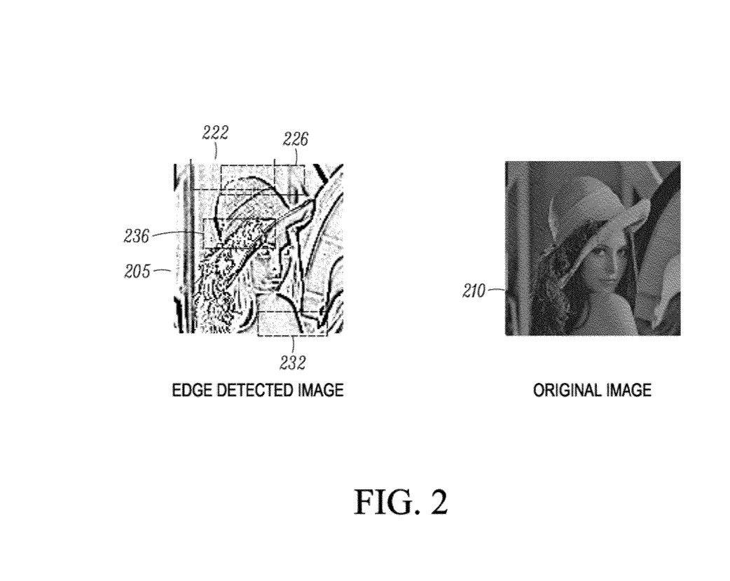

FIG. 2 illustrates an example of an original image 210 and an edge detected image 205. Edges characterize boundaries and are therefore a problem of fundamental importance in image processing. Edges in images are areas with strong intensity contrasts, e.g. a jump in intensity from one pixel to the next. Edge detecting an image is a common practice in image compression algorithms that significantly reduces the amount of data in the image and filters out less useful information while preserving important structural properties in the image. Various edge detection algorithms may be used in this disclosure to analyze the rendered image content.

Given a closed caption or graphics display with a particular window geometry (the geometry of rectangle window options 222, 226, 232, 236), placing that graphics window in an area of the image with a lower number of edge pixels can be presumed to be safer than an area with a larger number of edge pixels. For example, several window position options 222, 226, 232, 236 are shown in FIG. 2. In practice, many more options are available. It is clear, for example, that window position option 236 has more edges than the other window position options 222, 226, 232. In this particular image 210, the window option 222 with the fewest edges is where the closed caption or graphics would be placed.

Edge detection is useful in video segments where there is less motion—like news or talk shows. Depending on the video frame sequence, the location of the overlying graphics display may stay in the option 222 location over several frames or jump from option 222 to option 232 and back. If changes in placement of the graphics display window become annoying to a user, the user can enable and disable having graphics presented in areas where there is a least amount of edges or information. Enabling and disabling dynamic selection of the graphics display window can also (or alternately) be controlled by the decoder itself when the decoder detects that motion and information change in a given video frame sequence have exceeded a certain threshold.

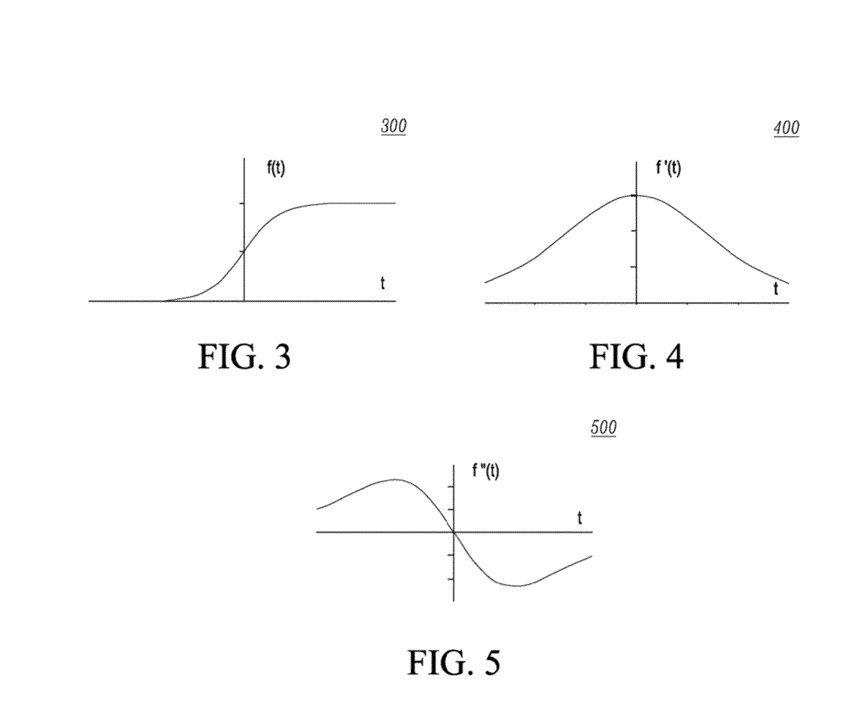

FIG. 3, FIG. 4, and FIG. 5 illustrate an exemplary method of performing edge detection. There are many ways to perform edge detection. However, the majority of different methods may be grouped into two categories, gradient and Laplacian. The gradient method detects the edges by looking for the maximum and minimum in the first derivative of the image. The Laplacian method searches for zero crossings in the second derivative of the image to find edges. An edge has the one-dimensional shape of a ramp and calculating the derivative of the image can highlight its location.

FIG. 3 illustrates a graph 300 of a one-dimensional continuous signal f(t). FIG. 4 illustrates a graph 400 of the gradient of the signal shown in graph 300. In one dimension, the gradient of the signal in graph 300 is the first derivative with respect to t. Graph 400 depicts a signal that represents the first order derivative.

Clearly, the derivative signal shows a maximum located at the center of the edge in the original signal. This method of locating an edge is characteristic of the “gradient filter” family of edge detection filters and includes the Sobel method. A pixel location is declared an edge location if the value of the gradient exceeds some threshold. As mentioned before, pixels having edges will have higher pixel intensity values than surrounding pixels without edges. So once a threshold is set, the gradient value can be compared to the threshold value and an edge can be detected whenever the threshold is exceeded. Furthermore, when the first derivative is at a maximum, the second derivative is zero.

As a result, another alternative to finding the location of an edge is to locate the zeros in the second derivative. This method is known as the Laplacian method. FIG. 5 illustrates a graph 500 depicting the second derivative of the signal in graph 300. The locations of the signal in graph 500 having a value zero depict an edge.

The present disclosure utilizes the Sobel method for detecting edges. There are many methods for detecting edges that can be utilized with the present disclosure in order to dynamically select a graphics display window. The Sobel method for detecting edges is used here as an example.

Based on the above one-dimensional analysis, the theory can be applied to two-dimensions as long as there is an accurate approximation to calculate the derivative of a two-dimensional image. The Sobel operator performs a 2-D spatial gradient measurement on an image and emphasizes regions of high spatial frequency that correspond to edges. Convolution is performed using a mask for the frame. In this embodiment, the Sobel Mask is used to perform convolution. Typically the Sobel Mask is used to find the approximate absolute gradient magnitude at each point in an input grayscale image.

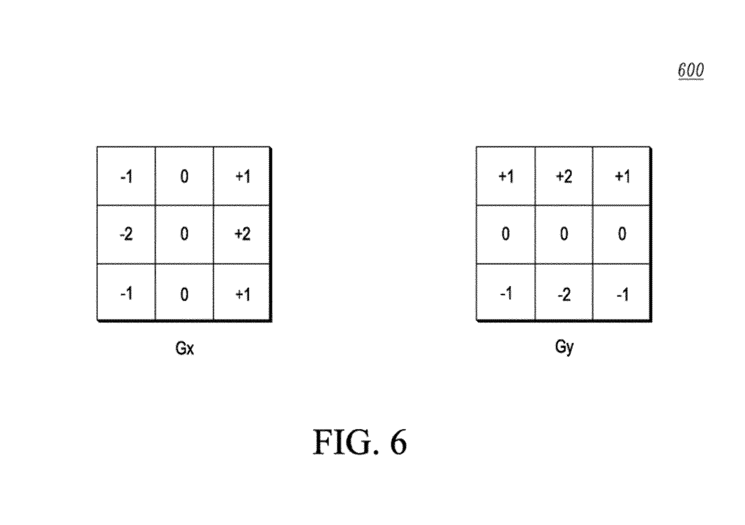

FIG. 6 illustrates a Sobel Mask. The Sobel edge detector uses a pair of 3×3 convolution masks 600, one estimating the gradient in the x-direction (columns) and the other estimating the gradient in the y-direction (rows). A convolution mask is usually much smaller than the actual image. As a result, the mask is slid over the image, manipulating a square of pixels at a time. In one embodiment, the decoder performs the Sobel method for the Luminance portion of the decoded frame.

The magnitude of the gradient is then calculated using the formula:

|G|=\sqrt{Gx²+G_{y}²}

where

An approximate magnitude can be calculated using:

|G|=|Gx|+|Gy|

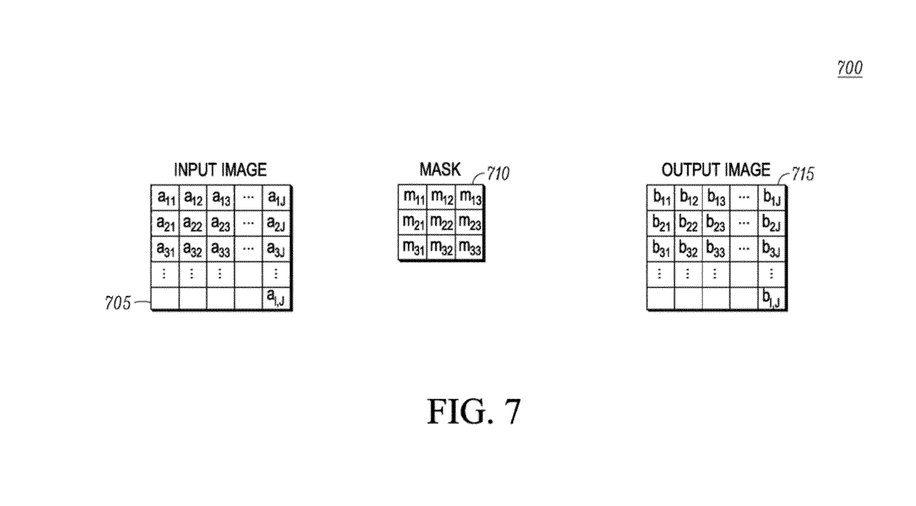

FIG. 7 illustrates a Sobel Method analysis according to one embodiment. The mask is slid over an area of the input image, changes that pixel's value and then shifts one pixel to the right and continues to the right until the mask reaches the end of a row. The mask then starts at the beginning of the next row. The example illustrated in FIG. 7 shows mask 710 being slid over the top left portion of input image 705 represented by the dotted outline. The formula shows how a particular pixel, b₂₂ (represented by the dotted line), in output image 715 is calculated. The center of the mask is placed over the pixel that is being manipulated in the image. The I & J values are used to move the file pointer in order to multiply, for example, pixel (a₂₂) by the corresponding mask value (m₂₂). It is important to note that pixels in the first and last rows, as well as the first and last columns cannot be manipulated by a 3×3 mask. This is because when placing the center of the mask over a pixel in the first row (for example), the mask will be outside the image boundaries. In this example, pixel b₂₂ of output image 715 would be calculated as follows:

b₂₂=(a₁₁*m₁₁)+(a₁₂*m₁₂)+(a₁₃*m₁₃)+(a₂₁*m₂₁)+(a₂₂*m₂₂)+(a₂₃*m₂₃)+(a₃₁*m₃₁)+(a₃₂*m₃₂)+(a₃₃*m₃₃).

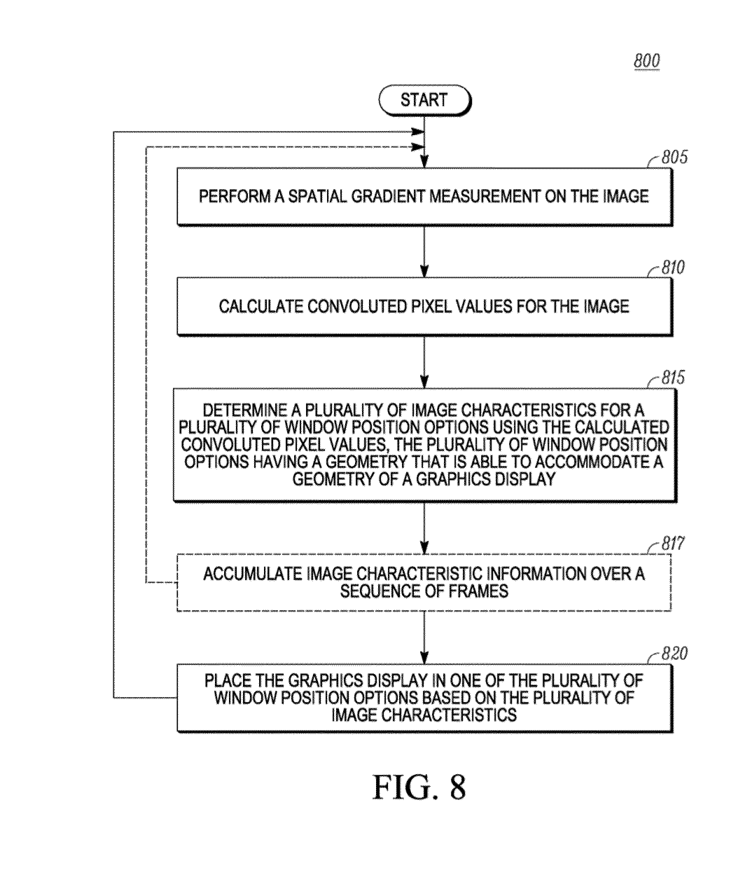

FIG. 8 illustrates a method 800 for dynamically selecting a graphics display window for an image, according to one embodiment. At step 805, a spatial gradient measurement is performed on the image. In one embodiment, the spatial gradient measurement is a two-dimensional spatial gradient measurement.

At step 810, convoluted pixel values are calculated for the image. The convoluted pixel values are calculated by using a mask on the image. In one embodiment, the mask is a Sobel Mask.

At step 815, a plurality of image characteristics is determined for a plurality of window position options using the calculated convoluted pixel values. The plurality of window position options has a geometry that is able to accommodate a geometry of the graphics display. The image characteristic can be a number of edges or edge pixels, an amount of information, or alternates to these two options.

At step 820, graphics, e.g. closed captioning data, are placed in one of the plurality of window position options based on the plurality of image characteristics. For the purposes of this disclosure, the term “geometry of closed captioning or graphics data” may refer to the number of acceptable lines of text and the acceptable line width of each line of text in a given captioning mode. Examples of captioning modes are “Roll On”, “Pop Up”, and “Paint On”.

In one embodiment, method 800 is a recurring method that determines a selected window position option for each image/frame in a video stream. In another embodiment, method 800 is a recurring method that determines a selected window position option based on image characteristic information accumulated (cumulative image characteristics) over a number of video images, e.g. a sequence of video frames in a video stream, using optional step 817. In one embodiment, where optional step 817 is used, the sequence of video frames corresponds to a succession of video frames after a scene change (large information change) in the video stream.

In one embodiment, the image characteristic is an amount of edges in the image. The amount of edges in an image may be calculated by counting as edges pixels having a convoluted pixel value exceeding a threshold value. Typical edge thresholds are chosen between [80,120] for a grayscale image.

In some cases a rendered image, e.g. frame, has more edges across the frame. The frame may have more content or objects than another previous frame. This situation may signify that the current shot, e.g. image or frame, is a close up shot.

In one embodiment, graphics are placed in an area of the image having a least number of edges. In the case of outdoor sports programs, e.g. baseball, the user may want to see more of the ground—most of the ground area will not reveal any edges. The center of the pitch may have many edges. A closer angle camera view might show more edges spread across the frame. Graphics rendering can be done effectively in such cases making sure that an area having the least information is chosen and without obliterating any critical views like the batsmen, main pitch, a fly ball catch, etc.

In one embodiment, a particular window position option may be selected due to information detected over a plurality of frames. For example, during a golf broadcast, a golf ball moves across the screen having either the sky or the green as a background. In this example, certain window position options are less likely to be selected due to the motion of the ball being detected over a plurality of frames. If, over a succession of images, a golf ball crosses from a lower right portion of a screen to an upper left portion of the screen, several window position options are unlikely to have a lowest number of edge pixels (e.g., lower right, center, and upper left). A graphics display can then be placed in lower left window position options or upper right window position options during that particular golf shot.

If the captions are pop-up style, a single line of known length may be placed on the lower margin of the screen without crossing many edges (either determined using “freestyle” window placement or determined using one of a plurality of pre-selected window options). If the captions are roll-on (up to four rows deep and up to 32 columns wide), the window may need to be carefully positioned during the golf shot sequence of images. If all the window placement options have greater than a threshold number of edge pixels detected, then the captions may be placed in a default position rather than the window position option with the fewest edge pixels.

In one embodiment, the image characteristic is an amount of information in an image. In this embodiment, graphics are placed in an area of the image having a least amount of information. In programs like news telecasts, typically there is very little motion observed except for a particular location. One example is a news telecast with tickers running on the bottom of the image. In this case, positioning the graphics in areas with least information (e.g., along the top of the image) will be very useful. For sequences with lot of motion, a user may choose to disable dynamic selection of the graphics display window. Alternately, the processor may disable dynamic selection of the graphics display window when the image characteristics are greater than a threshold.

In one embodiment, the image is one of a plurality of video frames presented in real-time. Dynamic positioning of the graphics display window may be controlled by selections received via user input. Dynamic positioning of the graphics display window may be automatically disabled when the decoder determines that the edges in the frame do not permit the decoder to relocate the graphics with the same geometry within the sequence of frames for a set time limit. In this case, the auto relocation can be turned off by the decoder and graphics may be rendered in a default position as specified by the protocol. After the auto relocation is turned off, the user may enable auto relocation at a later time. This scenario is possible when there is a lot of action in the scene, close up shots with lots of details, etc.

In one embodiment, graphics are placed in an area of an image having a least amount of edges that can accommodate a geometry of the graphics, e.g. the actual closed-captioning data. In this embodiment (e.g., pop-up), a particular least edges location matches the exact geometry of the graphics. For this embodiment, since the least edges selection location matches the exact geometry of the graphics, there will not be a situation where the least edges selection location is too small to fit a given geometry of the closed-caption data. If, however, the least edges option has greater than a threshold number of edge pixels, the decoder may choose the default position for displaying the graphics data.

In one embodiment, pre-selected areas may be defined for limiting the number of window placement options within an image. For example, an image, e.g. a frame, can be divided into four quadrants. The least edge/information detection method will initially operate only on these pre-selected quadrants and then operate within one selected quadrant when placing the closed-captioning data.

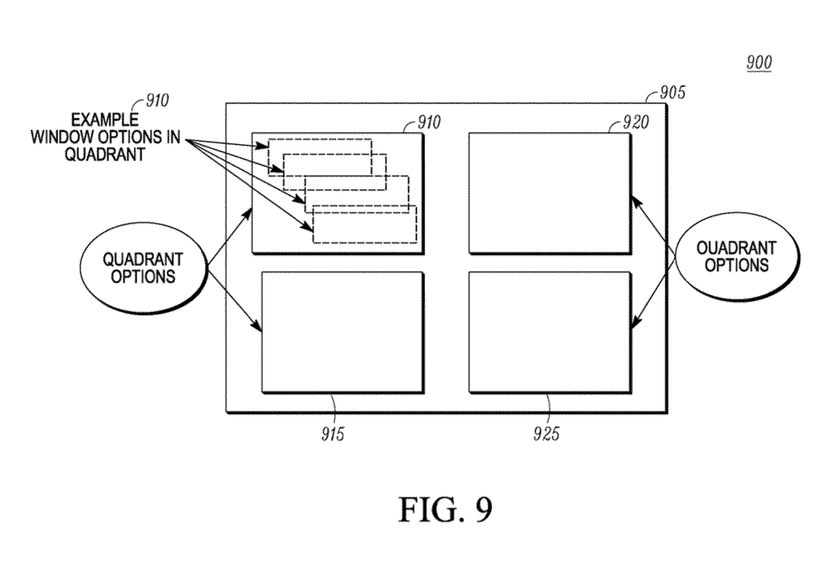

FIG. 9 illustrates one embodiment 900 of an image having pre-selected areas for window position options. In this embodiment, the pre-selected areas are four areas or quadrants resembling a 2×2 matrix. Image or frame 905 is divided into four quadrants 910, 915, 920, 925. Edge detection is done over every frame. The quadrant with the least edges and/or information is chosen for the placement of the graphics display window. Within the chosen quadrant, the graphics display window may be dynamically positioned as previously described with respect to FIG. 8 (starting at step 815 and confining the plurality of window positions options within the chosen quadrant). Thus, FIG. 9 shows four example graphics display window placement options within area 910. In practice, many more options are available.

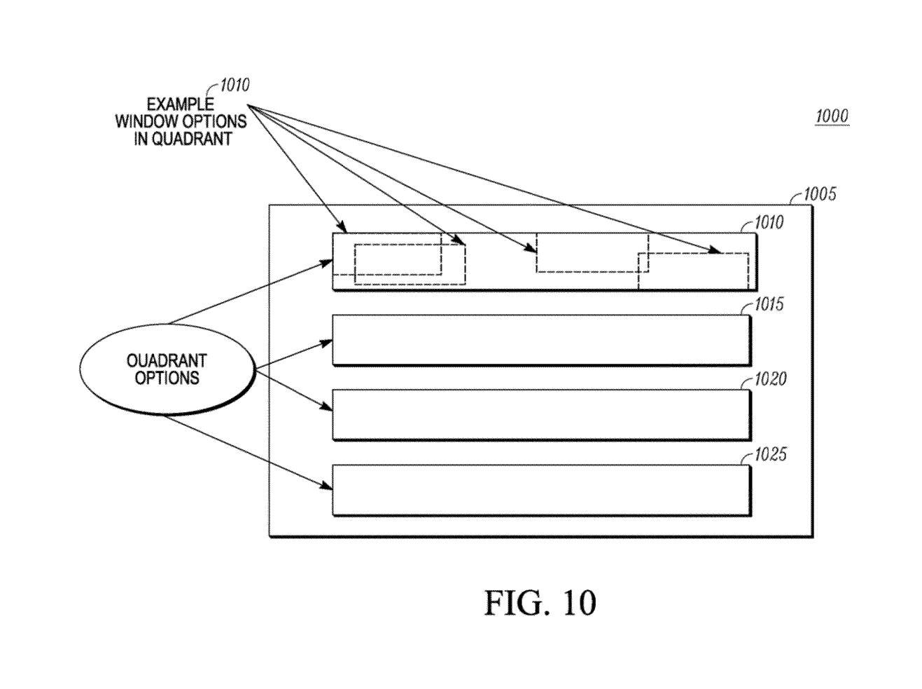

FIG. 10 illustrates another embodiment 1000 of an image having pre-selected areas for window position options. In this embodiment, the window position options are four areas or quadrants resembling a 1×4 matrix. Image or frame 1005 is divided horizontally into four quadrants 1010, 1015, 1020, 1025. Edge detection is done over every frame. The quadrant with the least edges and/or least amount of information is chosen for the placement of a graphics display window. Within the chosen quadrant, the graphics display window may be dynamically positioned as previously described with respect to FIG. 8 (starting at step 815 and confining the plurality of window positions options within the chosen quadrant). Thus, four graphics display window options are shown as examples in quadrant 1010. In practice, many more options are available.

Although FIGS. 9-10 both show four pre-selected areas, other numbers (2 or more) of areas may be implemented. Also, although FIGS. 9-10 show areas of equivalent size and geometry, in other implementations the areas may have differing sizes and/or shapes. Additionally, the areas may be overlapping instead of non-overlapping as shown in FIGS. 9-10.

The Advanced Television Closed Captioning (ATVCC) standard allows 9600 bits/sec out of which Electronic Industries Alliance (EIA) 608 (analog captions) may be 960 bps. EIA 708 can carry 8640 bps, which means, per frame at 60 Hz one can have 20 bytes allocated for closed captioning.

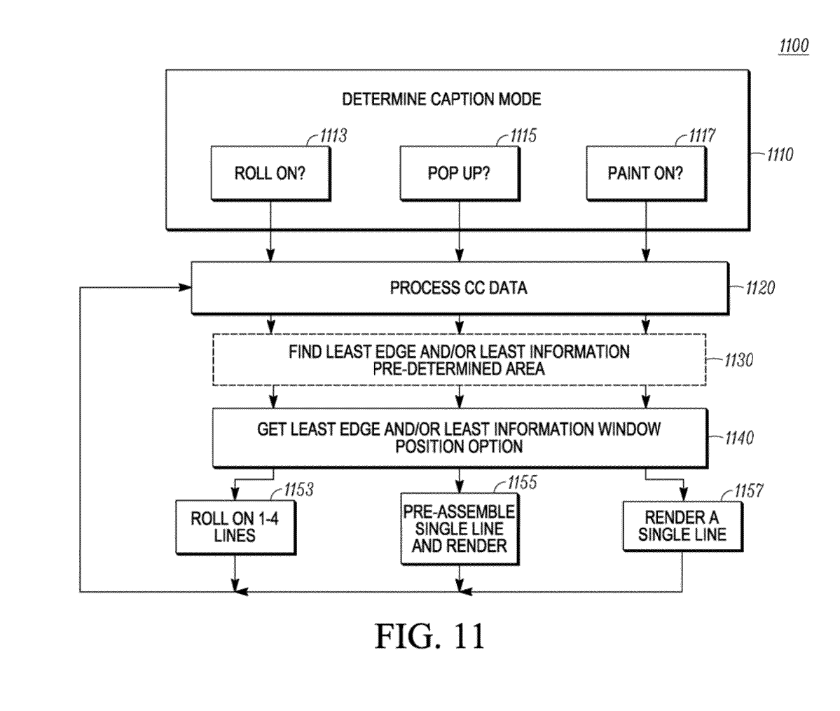

FIG. 11 illustrates a method 1100 for dynamically positioning a graphics display window, according to one embodiment. At step 1110, a closed-caption mode is determined. Captions may be displayed in “Roll On” 1115, “Paint On” 1125, or “Pop Up” 1120 modes. Based on the captioning mode, a window geometry can be established preliminarily.

Roll On mode 1113 was designed to facilitate comprehension of messages during live events. Captions are wiped on from the left and then roll up as the next line appears underneath. One, two, three, or four lines typically remain on the screen at the same time. Because the graphics could be up to four lines deep, the graphics display window may be up to 4 rows deep and up to 32 columns wide. Note that the geometry of a graphics display window in roll-on mode is potentially larger compared to the other two modes that will be described below.

In Paint On mode 1115, a single line of text is wiped onto the screen from left to right. The complete single line of text remains on the screen briefly, and then disappears. In paint on mode, the line length can increase. As such, the controller might account for the longest possible line length when determining the graphics display window geometry. For example, in paint-on mode, the graphics display window may be set to 1 row deep and 32 columns wide.

Pop Up mode 1117 is generally less distracting to a viewer than modes 1113 and 1115; however, the complete line must be pre-assembled off screen prior to rendering any part of the line. In pop up mode, both the line depth and length are known and the graphics display window may be exactly the row depth and column width of the known pop-up graphics. As such, placement of graphics can be very precise.

At step 1120, closed-caption data is processed. At optional step 1130, a single area from a plurality of pre-determined areas is found, e.g., using edge detection methods as discussed previously to find the pre-determined area with the fewest edges (or least information). Using the closed-caption data from step 1120 and the caption mode from step 1110, the graphics display window geometry can be set. At step 1140, a window position option having a least amount of edges and/or information is selected (within the found one of the plurality of pre-determined areas, if step 1130 occurs). In one embodiment, method 800 is used to determine a “freestyle” window position option having a least amount of edges and/or information without using step 1130. In other words, method 800 may be used to select one of a plurality of window position options where the plurality of window position options account for the entire image. Method 800 may also be used to select one of a plurality of fixed or pre-selected areas (for example, one of quadrants 910, 915, 920, 925 or one of quadrants 1010, 1015, 1020, 1025) by using step 1130 prior to selecting a particular graphics window position within the selected area per step 1140.

The renderer is free to alter the font size and also position line breaks anywhere in the graphics display window. Typically, line breaks are inserted when a space is detected between two characters.

The decision making point for repositioning a graphics display window can be fixed differently for each of the rendering styles 1113, 1115, 1117. For Roll On mode 1113, for example, when four lines of text are already displayed at a given time and a fifth line has to appear, a determination can be made (using FIG. 8) as to the best position for the graphics display window. In the case of a news program using a two-stage positioning of a graphics display window (i.e., with both steps 1130 and 1140), the quadrant for the graphics display window may be quite stable, because the amount of edges in a given quadrant may not change often during the broadcast. For Pop Up 1115 and Paint On 1117 modes, a determination is made as to which quadrant has the least amount of edges every time a new line of data has to be “popped up” or “painted on” (i.e., after every line is completed).

The processes described above, including but not limited to those presented in connection with FIGS. 6-11, may be implemented in general, multi-purpose, or single purpose processors. Such a processor will execute instructions, either at the assembly, compiled, or machine-level, to perform that process. Those instructions can be written by one of ordinary skill in the art following the description presented above and stored or transmitted on a computer readable medium, e.g., a non-transitory computer-readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

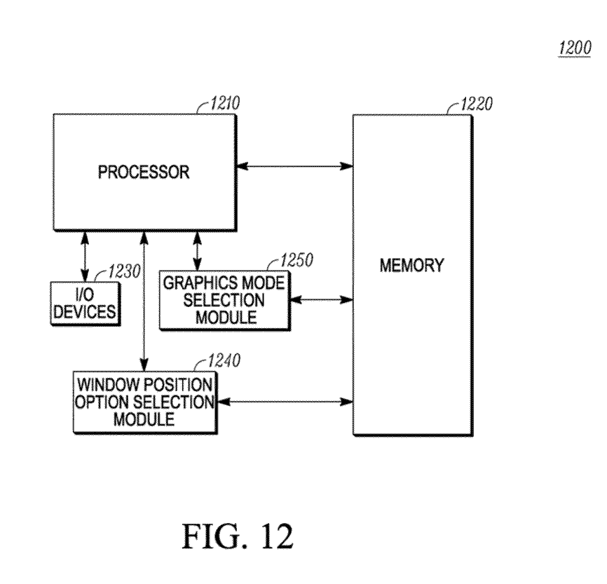

FIG. 12 illustrates a block diagram of an example device 1200. Specifically, device 1200 can be employed to dynamically selecting a graphics, e.g. closed captioning, display window for an image. Device 1200 may be implemented in content provider 105, display 140, or end user device 115, 125.

Device 1200 comprises a processor (CPU) 1210, a memory 1220, e.g., random access memory (RAM) and/or read only memory (ROM), a graphics, e.g. closed captioning, window position option selection module 1240, graphics mode selection module 1250, and various input/output devices 1230, (e.g., storage devices, including but not limited to, a tape drive, a floppy drive, a hard disk drive or a compact disk drive, a receiver, a transmitter, and other devices commonly required in multimedia, e.g., content delivery, encoder, decoder, system components, Universal Serial Bus (USB) mass storage, network attached storage, storage device on a network cloud).

It should be understood that window position option selection module 1240 and graphics mode selection module 1250 can be implemented as one or more physical devices that are coupled to CPU 1210 through a communication channel. Alternatively, window position option selection module 1240 and graphics mode selection module 1250 can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 1220 of the computer. As such, window position option selection module 1240 (including associated data structures) and graphics mode selection module 1250 (including associated data structures) of the present disclosure can be stored on a computer readable medium, e.g., RAM memory, magnetic or optical drive or diskette and the like.

While the foregoing is directed to embodiments of the present disclosure, other and further embodiments may be devised without departing from the basic scope thereof, and the scope thereof is determined by the claims that follow.

What is claimed is:

1. A method for dynamically placing a graphics display window placement within an image, comprising:
performing a two-dimensional spatial gradient measurement on the image;
calculating convoluted pixel values for the image;
determining a plurality of image characteristics for a plurality of window position options using the calculated convoluted pixel values, the plurality of window position options having a geometry that is able to accommodate a geometry of a graphics display;
placing the graphics display in one of the plurality of window position options based on the plurality of image characteristics.

2. The method of claim 1, wherein the convoluted pixel values are calculated by using a mask on the image.

3. The method of claim 1, wherein image characteristics are numbers of edges and the placing comprises:
placing the graphics display in the window position option with a lowest number of edges.

4. The method of claim 3, wherein the numbers of edges in the image are calculated by counting as edges pixels having a convoluted pixel value exceeding a threshold value.

5. The method of claim 3, wherein the graphics display is closed captioning data and the placing comprises:
placing closed captioning data in the window position option having a least number of edges.

6. The method of claim 1, wherein the image characteristics are amounts of information in the image and the placing comprises:
placing the graphics display in the window position option with the lowest amount of information.

7. The method of claim 1, wherein the placed graphics display is presented in pop-up mode.

8. The method of claim 1, wherein the placed graphics display is presented in roll-on mode and the geometry is deeper than the graphics display.

9. The method of claim 1, wherein the placed graphics display is presented in paint-on mode and the geometry is longer than the graphics display.

10. The method of claim 1, wherein the image is one of a sequence of video frames and wherein a plurality of cumulative image characteristics for the plurality of window position options is determined for the sequence of video frames.

11. The method of claim 10, wherein the placing is disabled by receiving a user input.

12. The method of claim 10, wherein the placing is disabled based on at least one of an amount of motion and an amount of information change in the sequence of the plurality of video frames.

13. The method of claim 10, wherein the placed graphics display is presented in roll-on mode.

14. The method of claim 10, wherein the placed graphics display is presented in paint-on mode.

15. The method of claim 10, wherein window position options are excluded from consideration based on the plurality of cumulative image characteristics.

16. The method of claim 1, further comprising after the calculating:
finding an area, from a plurality of pre-determined areas, based on the calculated convoluted pixel values, and
wherein the plurality of window position options is only within the area.

17. An apparatus for dynamically placing a closed captioning display window within an image, comprising:
a memory; and
a processor configured to perform the following:
perform a two-dimensional spatial gradient measurement on the image;
calculate convoluted pixel values for the image;
determine a plurality of image characteristics for a plurality of window position options using the calculated convoluted pixel values, the plurality of window position options having a geometry that is able to accommodate a geometry of a graphics display;
place the graphics display in one of the plurality of window position options based on the plurality of image characteristics.

18. The apparatus of claim 17 wherein the processor is also configured to perform the following:
finding an area, from a plurality of pre-determined areas, based on the calculated convoluted pixel values, and
wherein the plurality of window position options is only within the area.

19. A non-transitory computer readable storage medium comprising instructions that, when executed by a processor, perform the following method for dynamically positioning a graphics display window within an image, comprising:
performing a two-dimensional spatial gradient measurement on the image;
calculating convoluted pixel values for the image;
determining a plurality of image characteristics for a plurality of window position options using the calculated convoluted pixel values, the plurality of window position options having a geometry that is able to accommodate a geometry of a graphics display;
placing the graphics display in one of the plurality of window position options based on the plurality of image characteristics.
